(19) United States
(12) Patent Application Publication
(10) Pub. No.: US 2014/0248865 A1
(43) Pub. Date: Sep. 4, 2014

(54) MOBILE DEVICE MANAGEMENT

(71) Applicant: Aegis Mobility, Inc., Vancouver (CA)

(72) Inventor: Stephen J. Williams, Port Moody (CA)

(73) Assignee: Aegis Mobility, Inc., Vancouver (CA)

(21) Appl. No.: 14/193,202

(22) Filed: Feb. 28, 2014

Related U.S. Application Data
(60) Provisional application No. 61/771,725, filed on Mar. 1, 2013.

(51) Int. Cl. H04W 4/02

(52) U.S. Cl. CPC H04W 4/027
USPC 455/418

(57) ABSTRACT

Aspects of the present disclosure correspond to the utilization of criteria for distinguishing between temporary changes to mobile communication device movement state in determining whether a mobile communication device context has changed. A mobile communication device can be configured to manage one or more aspects of functionality of the mobile communication device based on a mobile communication device context. At some point, the mobile communication device can determine a transition to a substantially stationary state. Rather than immediately transitioning the mobile communication device context, the mobile communication device can define a period of time in which additional changes to the mobile communication device movement state can be detected. Accordingly, if the mobile communication device movement state transitions again to a non-stationary movement state within the guard period, the mobile communication device context remains in the non-stationary movement state and never transitions.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

Generally described, mobile communication devices can currently be utilized in a variety of environments and can be equipped and configured to provide different functionality, such as voice communications, messaging, data processing, data transmission, and the like. Often, mobile communication devices are sufficient portable such that users are capable of being in a state of movement while accessing the mobile communication device. For example, users can have a mobile communication device with them in a vehicle that is in motion.

In one aspect, communities have passed legislation that prohibits certain types of mobile communication device functionality if a user is engaged in specific types of movement. For example, many communities have passed laws making it a traffic violation to access/use messaging functionality if the user is driving a vehicle. In another aspect, organizations, such as businesses, have also set mobile communication device policies that can also prohibit or limit types of mobile communication device functionality if a user is engaged in specific types of movement. For example, an organization can prohibit all access to a mobile communication device if the user (e.g., a member/employee) is driving a vehicle, walking, etc.

To encourage compliance with laws, regulations or policies, mobile communication devices can be equipped with executable software that is operable to disable some functionality of the mobile communication device when the user is engaged in some type of motion. The software typically removes the restrictions when the device is considered to no longer be in motion. However, such solutions can be deficient in situations in which the lack of movement, or motion, is temporary. For example, if a user in a vehicle is stopped temporarily at a traffic light, the software can enable mobile communication device functionality prematurely. Additionally, in other situations, such solutions may unnecessarily limit mobile communication device functionality for a user that is in a vehicle, but not a driver.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of one embodiment of a communication management environment including a communication management system and a number of mobile communication devices;

FIG. 2 is a block diagram illustrative of aspects of the communication management system of FIG. 1 in an embodiment of the communication management environment;

FIG. 3 is a block diagram illustrative of aspects of the mobile communication device of FIG. 1 in an embodiment of the communication management environment;

FIGS. 4A and 4B are block diagrams illustrating the processing of mobile communication device context information by a mobile device and the processing by the communication management system;

FIG. 5 is flow diagram illustrative of movement context assessment algorithm implemented by a mobile communication device in providing mobile communication device context information to a communication management system; and

FIGS. 6A and 6B are flow diagrams illustrative of movement context assessment algorithm implemented by a mobile communication device in providing mobile communication device context information to a communication management system.

### DETAILED DESCRIPTION

The present disclosure corresponds generally to mobile device management. More specifically, aspects of the present disclosure correspond to the utilization of criteria for distinguishing between temporary changes to mobile communication device movement state in determining whether a mobile communication device context has changed. In an illustrative embodiment, a mobile communication device can be configured to manage one or more aspects of functionality of the mobile communication device based on a mobile communication device context. Illustratively, at least a portion of the mobile device context can be characterized incorporating different states of movement including a stationary state (or substantially stationary) and one or more states of movement. For purposes of the illustrative example, the mobile communication device can be configured, directly or indirectly, to limit functionality if a current mobile device context is associated with a non-stationary movement state.

With continued reference to the illustrative example, at some point, the mobile communication device can detect an initial change of a mobile communication device movement state that might indicate a transition to a substantially stationary state. Rather than immediately transitioning the mobile communication device context to reflect such a stationary movement state, the mobile communication device, or other device, can define a period of time, generally referred to as a guard period, in which additional changes to the mobile communication device movement state can be detected without causing a change in a mobile communication device movement context. Accordingly, if the mobile communication device movement state transitions again to a non-stationary movement state within the guard period, the mobile communication device context remains in the non-stationary movement state and never transitions. All policies and restrictions associated with the non-stationary context have remained intact.

Alternatively, if the guard period expires with a determination that the mobile communication device has transitioned back to a non-stationary movement state, the mobile communication device context can be modified in accordance with a stationary movement state, which may modify the functionality provided by, or enabled on, the mobile communication device. Still further, in another example, users may be provided with the ability to designate a stationary state or request a transition of the mobile communication device context. For example, a user may be presented with an interface that allows a designation of an “end of trip” or “stopped.” In this embodiment, the mobile communication device can continue to monitor for state transitions during the guard period. Accordingly, if the mobile communication device movement state transition again to a non-stationary movement state within the guard period, the mobile communication device context can transition back to a non-stationary movement state and the user override can be processed based on error or potential fraud.

In a further illustrative example, the mobile communication device context can be utilized in an illustrative call and session management system, the call and session management system operates by mediating call or session management as a function of a mobile subscriber's context as determined by algorithms running on the mobile device, within the mobile network or a combination of the two. With reference to a specific embodiment, illustratively, the communication management system can process mobile subscriber's context. Once a mobile subscriber's context is determined, the call and session management system assigns a specific rule or policy set for the mobile subscriber in each context. Once assigned, the call and session management system, through a server, then informs the appropriate network element including but not limited to the MSC, SMSC, PCRF, etc. Sessions can then be mediated by the network elements as instructed by the policy provided by call and session management system.

Although aspects of the system will be described to the drawings, flow diagrams, screen interfaces, and specific examples, one skilled in the relevant art will appreciate that the disclosed embodiments are illustrative in nature. Specifically, reference to specific wireless transmission protocols, illustrative context categories, or illustrative examples should not be construed as limiting should not be construed as limiting.

### System Overview

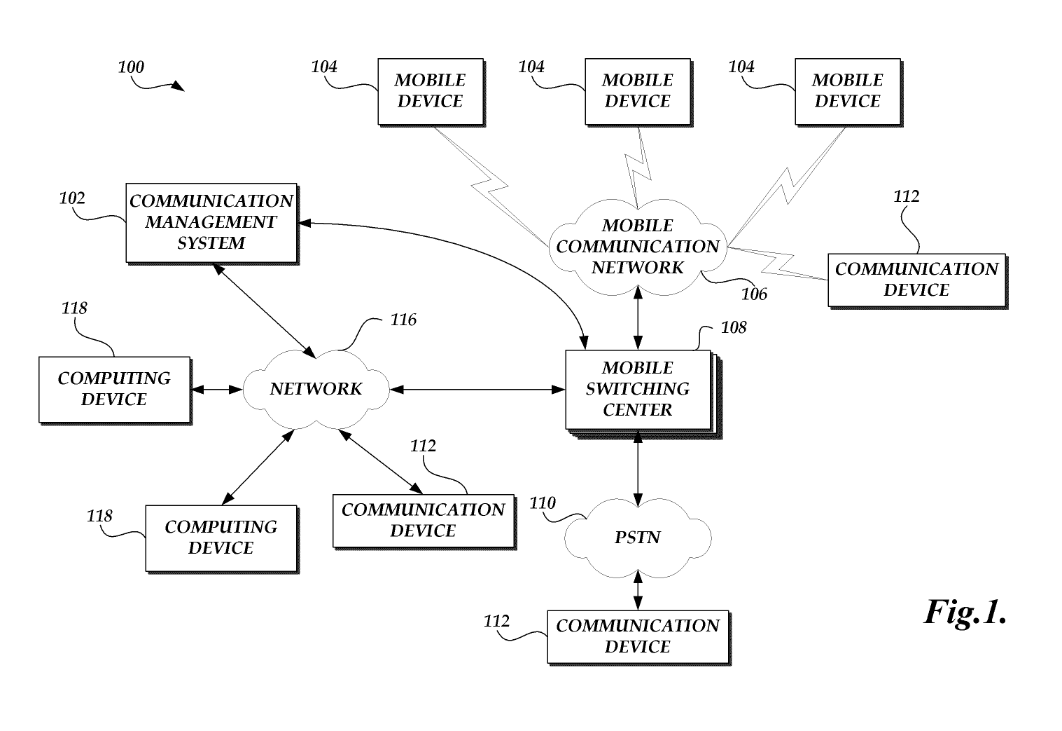

With reference now to FIG. 1, a block diagram illustrative of a communication management environment 100 for managing mobile subscriber's context will be described. As illustrated in FIG. 1, the communication management environment 100 includes a communication management system 102 for processing data communications and mobile subscriber's context. In one aspect, the communication management system 102 maintains mobile communication device profiles that are provisioned to establish the availability for the mobile communication device to receive and transmit data via a communication network based on a current context. In another aspect, the communication management system 102 can further process mobile subscriber context information to determine additional mobile device context states or to determine attributes of a mobile subscriber's device.

To manage requested communications, the communication management system 102 communicates with corresponding subsystems responsible for establishing wireless communication channels, such as mobile switching center 108. The communication management system 102 can communicate with the mobile switching center 108 via a direct communication connection, a secure communication channel via a communication network, such as communication network 114, or via a public communication network.

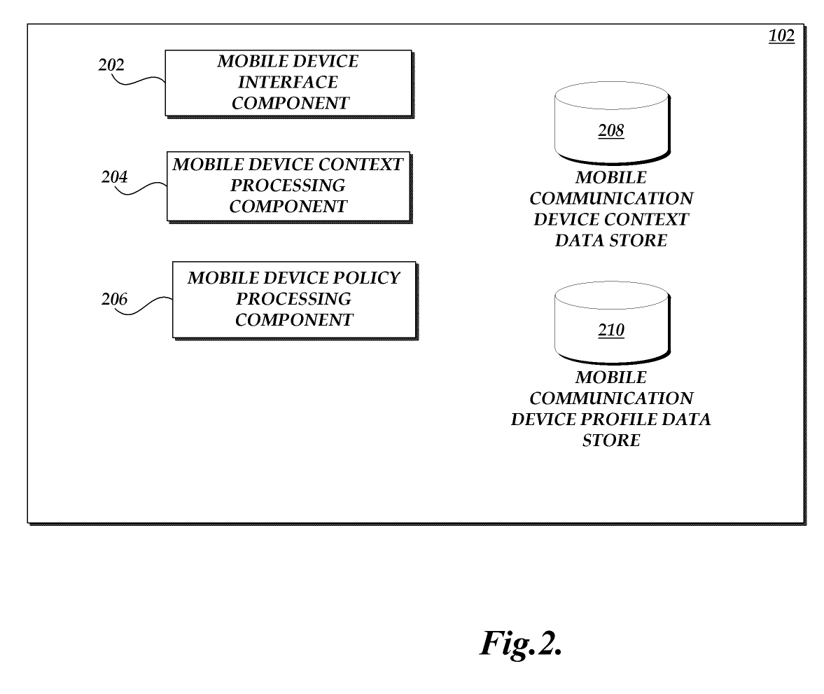

In an illustrative embodiment, the communication management system 102 provides data communication mitigation options in the event that the mobile communication device is unavailable to send or receive data communications. Still further, the communication management system 102 facilitates the generation of various graphical user interfaces for provisioning or managing mobile communication device profiles via computing devices 116. Illustrative components of the mobile communication management system 102 will be described in greater detail with regard to FIG. 2.

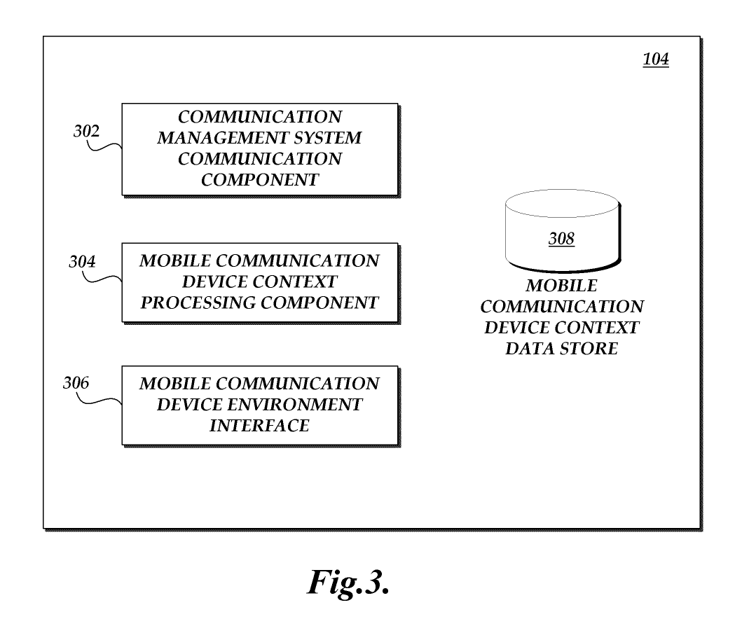

With continued reference to FIG. 1, the communication management environment 100 can include a number of mobile communication devices 104. The mobile communication devices 104 can correspond to wide variety of devices or components that are capable of initiating, receiving or facilitating communications over a communication network including, but not limited to, personal computing devices, hand-held computing devices, integrated components for inclusion in computing devices, home electronics, appliances, vehicles, and/or machinery, mobile telephones, modems, personal digital assistants, laptop computers, gaming devices, and the like. In an illustrative embodiment, the mobile communication devices 104 include a wide variety of software and hardware components for establishing communications over one or more communication networks, including wireless or wired mobile communication networks 106. The mobile communication devices 104 can be associated with one or more users for managing data communications according mobile communication device contexts. Illustrative components of a mobile communication device will be described in greater detail with regard to FIG. 3.

An illustrative communication management environment 100 can include a number of additional components, systems and/or subsystems for facilitating communications with the mobile communication devices 104 or the communication management system 102. The additional components can include one or more mobile switching centers 108 for establishing communications with the mobile communication devices 104 via the mobile communication network 106, such as a cellular radio access network, a wireless network based on the family of IEEE 802.11 technical standards (“WiFi”), a wireless network based on IEEE 802.16 standards (“WiMax”), and other wireless networks or wireless communication network standards. The operation of mobile communication networks, such as mobile communication network 106 are well known and will not be described in greater detail.

As illustrated in FIG. 1, the mobile switch center 108 includes interfaces for establishing various communications with via the communication network 116, such as the Internet, intranets, private networks and point-to-point networks. In one example, the mobile switch center 108 can include interfaces for establishing communication channels with various communication devices 112, such as landline telephones, via a public switched telephone network (PSTN) 110.

The mobile switch center 108 can also include interfaces for establishing communication channels with various communication network-based communication devices 112, such as a VoIP communication device. Still further, the mobile switch center 108 can include interfaces for establishing communication channels with a mobile-based communication device 112, such as another mobile communication device. For example, the communication devices 112 can correspond to a third-party mobile communication that establishes an audio communication channel with a mobile communication device 104. Accordingly, although communication network 116 is illustrated as a single communication network, one skilled in the relevant art will appreciate that the communication network can be made up of any number of public or private communication networks and/or network connections.

The various communication devices 112 can include the hardware and software components that facilitate the various modes of operation and communication, such as via wired and wireless communication networks. Additionally, the computing devices 118 can include various hardware and software components, such as a browser software application, that facilitate the generation of the graphical user interfaces for provisioning and managing mobile communication device profiles as will be described below.

One skilled in the relevant art will appreciate that the components and configurations provided in FIG. 1 are illustrative in nature. Accordingly, additional or alternative components or configurations, especially regarding the additional components, systems and subsystems for facilitating communications may be utilized.

With reference now to FIG. 2, illustrative components for the communication management system 102 will be described. Although the operation of the various functions associated with the communication management system 102 will be described with regard to below subcomponents, one skilled in the relevant art will appreciate that the subcomponents are illustrative in nature. Illustratively, the communication management system 102 may be associated with computing resources such as central processing units and architectures, memory (e.g., RAM), mass storage or persistent memory, graphics processing units, communication network availability and bandwidth, etc. Generally, however, the communication management system 102 may include one or more processing units, such as one or more CPUs. The communication management system 102 may also include system memory, which may correspond to any combination of volatile and/or non-volatile storage mechanisms. The system memory may store information that provides an operating system component, various program modules, program data or other components. The communication management system 102 performs functions by using the processing unit(s) to execute instructions provided by the system memory. The communication management system 102 may also include one or more types of removable storage and one or more types of non-removable storage. Still further, the communication management system 102 can include communication components for facilitating communication via wired and wireless communication networks, such as communication network 116. Accordingly, a communication management system 102 may include additional components or alternative components to facilitate one or more functions. Additionally, although the various subcomponents are illustrated as integrated into a communication management system 102, one or more of the components may be implemented in a distributed manner over a communication network and/or be implemented as a network service, e.g., a Web service.

As illustrated in FIG. 2, the communication management system 102 includes a mobile device interface component 202 for establishing communications with a mobile communication device 104. In an illustrative embodiment, the mobile device interface component 202 corresponds to a component for facilitating the bi-lateral transfer of data, such as mobile device context information, context assessment algorithms, etc., between the mobile communication device 104 and the communication management system 102. The mobile device communication component 202 can include software and hardware components necessary to establish one or more communication channels corresponding to various communication protocols such as Bluetooth, the family of IEEE 802.11 technical standards (“WiFi”), the IEEE 802.16 standards (“WiMax), short message service (“SMS”), voice over IP (“VoIP”) as well as various generation cellular air interface protocols (including, but not limited to, air interface protocols based on CDMA, TDMA, GSM, WCDMA, CDMA2000, TD-SCDMA, WTDMA, LTE, OFDMA and similar technologies).

The communication management system 102 can also include a mobile communication device context processing component 204. In one aspect, the mobile communication device context processing component 204 can determine the availability of a mobile communication device 104 for communication based on processing mobile communication device context information according to a mobile communication device profile. The mobile communication device context processing component 204 can execute various processes or algorithms for processing transmitted mobile communication device context information to determine mobile communication device availability to transmit or receive data. Additionally, the mobile communication device context processing component 204 can also manage the various context assessment processes or algorithms and updates to existing previously stored context assessment processes and algorithms that are transmitted and executed by the mobile communication devices 104.

With continued reference to FIG. 2, the communication management system 102 can include a mobile communication device policy processing component 206 for processing mobile subscriber's context policies. Illustratively, the mobile communication device policy processing component 206 can process requests for establishment of communication channels or maintenance of established communication channels based on evaluation one or more context policies. Additionally, the mobile communication device policy processing component 206 can evaluate mobile subscriber's context information to determine additional context states or to make additional assessments about the mobile subscriber's device. For example, the mobile communication device policy processing component 206 can process successive mobile subscriber context information to determine location or movement attributes for mobile subscriber devices.

With continued reference to FIG. 2, the communication management system 102 can also include a mobile communication device context data store 208 for maintaining mobile communication device context information previously transmitted by the mobile communication devices 104 or for maintaining the mobile communication device context assessment algorithms utilized by the mobile communication devices to process inputs into mobile communication device context. In one embodiment, the mobile communication device context information may be accessible, or otherwise published, to other computing devices, network based services, or users via the communication network 114.

The communication management system 102 can further include a mobile communication device profile data store 210 for maintaining mobile communication device profiles. The mobile communication device profile data store 212 may be one or more databases configured to provide the communication processing component 204 required data to determine mobile communication device data filter templates based on mobile communication device context. As will be described in greater detail below, the mobile communication device profile data defines the availability of the mobile communication device 104 to receive or transmit data as a function of a current mobile communication device context.

With reference now to FIG. 3, illustrative components for the mobile communication device 104 will be described. Although the operation of the various functions associated with the mobile device 104 will be described with regard to below components, one skilled in the relevant art will appreciate that the components are illustrative in nature. Accordingly, a mobile device 104 may include additional components or alternative components to facilitate one or more functions. Additionally, although the various subcomponents are illustrated as integrated into a mobile device 104, one or more of the components may be implemented in a distributed matter over a communication network or be implemented as a network service, e.g., a Web service.

As illustrated in FIG. 3, the mobile device 104 includes a communication management system communication component 302 for facilitating communications with the communication management system 102. As described above with regard to the mobile device communication component 202 (FIG. 2), the communication management system communication component 302 facilitates the bi-lateral transfer of data between the mobile communication device 104 and the communication management system 102. One skilled in the relevant art will appreciate that the communication management system communication component 302 can include software and hardware components necessary to establish one or more communication channels corresponding to various communication protocols for establishing the bi-lateral communication channels. Moreover, although the communication management system communication component 302 is illustrated as a separate component, the functionality of the component may be integrated, or otherwise combined, with one or more hardware or software components utilized by the mobile communication device 104 to make communication channels (e.g., cellular communication channels or SMS communication channels as part of the designed function of the mobile device).

As will be described in greater detail below, the communication management system communication component 302 transmits current mobile device context information in accordance with the context assessment algorithms on the mobile device 104. Once a current mobile communication device context is established, the communication management system 302 can limit additional transmission of context information upon detection of a change in mobile communication context information. Additionally, in an alternative embodiment, the communication management system communication component 302 may also transmit, or otherwise publish, mobile communication device context information to additional recipients, such as communication network resources such as Web sites or network services, or to other peer destinations.

The mobile communication device 104 can also include a mobile communication device context information component 304 for processing a set of inputs corresponding to a mobile device environment to determine mobile device context information. Illustrative context assessment algorithms or processes for determining mobile device context information will be described in greater detail below. The mobile communication device contexts can identify or describe aspects of the mobile communication device 104, aspects of the mobile communication device environment, or aspects of the user associated with the mobile communication device. For example, the mobile communication device context corresponds to a determination of various states of movement/travel, such as in a non-transitory state, an in-transit state (including city/urban travel transit, highway transit, and in-flight transit states), a journey onset state and a journey termination state.

In another example, the mobile communication device context corresponds to a determination of whether a mobile communication device's present location is within a geospatial boundary, also referred to as geofencing (including within the geospatial boundary, on a border of the geospatial boundary, or outside the geospatial boundary). One skilled in the relevant art will appreciate that the identified mobile device contexts are not exhaustive and that any number of additional mobile device contexts, or variations of the identified mobile communication device contexts, may also be defined for the mobile communication device 104. An illustrative system and methodologies for determining mobile communication device context or processing mobile communication device context information is described in co-pending and commonly assigned U.S. application Ser. No. 12/040,832, entitled MANAGEMENT OF MOBILE DEVICE COMMUNICATION SESSIONS TO REDUCE USER DISTRACTION, and filed on Feb. 29, 2008, which is incorporated herein by reference.

With continued reference to FIG. 3, the mobile communication device 104 can also include a mobile communication device environment interface 306 for obtaining inputs corresponding to a mobile communication device environment. In an illustrative embodiment, the set of inputs can include information from one or more sensors that are capable of transmitting information or obtaining information based on NFC signals. Generally described, NFC may correspond to one of several radio frequency standards defining communication protocols and data exchange formats. Examples of NFC standards include, but are not limited to, the International Organization for Standards (“ISO”) 1443, ISO 18092 standards, as well as additional standards promulgated by one or more standards organizations. Illustrative sensors that may be able to have NFC capability include accelerometers, altimeters, compasses, gyroscopes, microphones, scales or other weight detection mechanisms, range finders, proximity sensors, gas or radiation detectors, electric current or electric induction detection, digital image sensors, thermometers and the like. Additionally, the set of inputs can correspond to one or more sensors that provide information to the mobile communication device separate from an NFC-based communication. Still further, the set of input can correspond to information obtained from communication network based resource such as calendaring information, identity or contact information and the like.

One skilled in the relevant art will appreciate that the set of inputs may be selected to correspond specifically to the particular algorithms utilized to calculate mobile communication device context. In one example, microphonic sensors may be used for detecting high noise levels from the embedded device microphone and using this context to permit only high importance work related calls and data session requests that pertain to the current work function. In another example, the sensor information can corresponds to a determination whether a Bluetooth headset or alternative hands free device is active in accordance with a corporate policy and local jurisdiction law.

The mobile communication device 104 can further include a mobile communication device data store 308 for storing input information from the mobile communication device environment interface 306, context information generated by the mobile communication device processing component 304 or the various context assessment algorithms or processes used by the mobile communication device processing component to generate the mobile communication device context information.

### Mobile Communication Device Data Processing

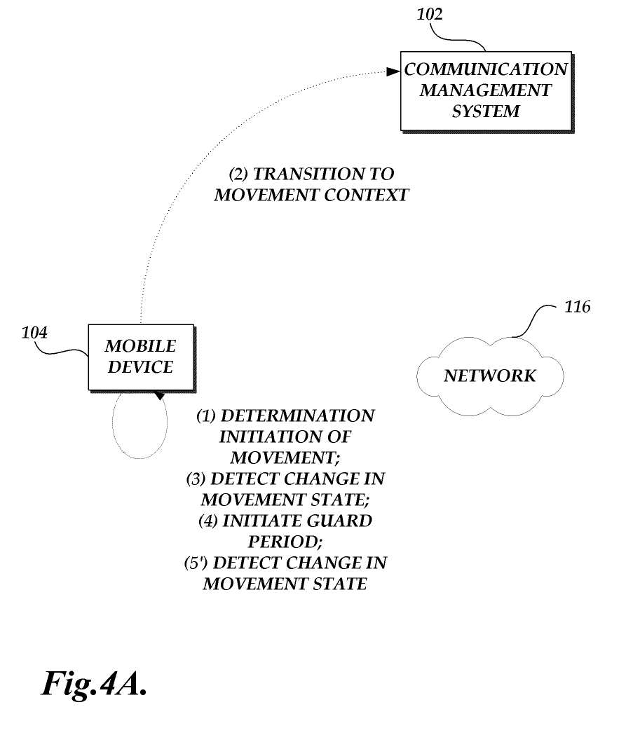

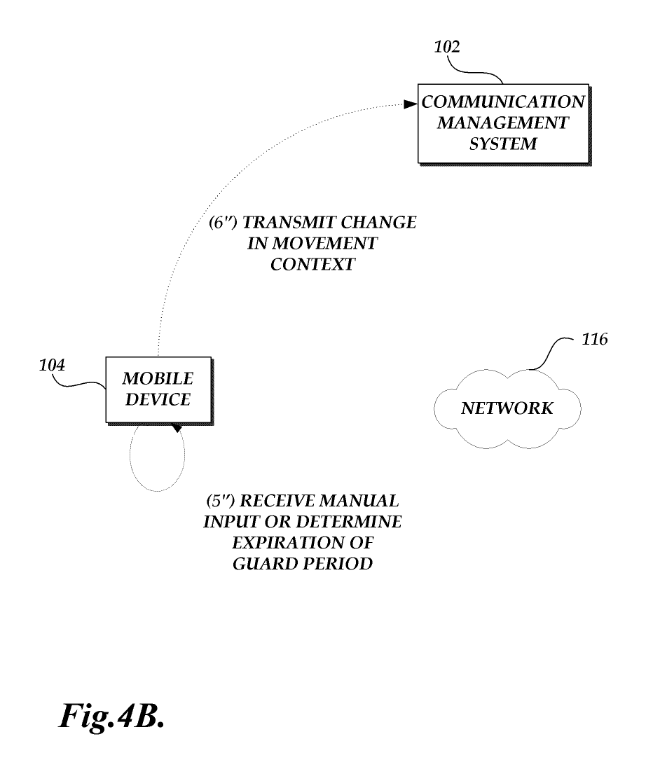

With reference now to FIGS. 4A-4B, the interaction between various components of the communication management environment 100 of FIG. 1 will be illustrated. For purposes of the example, however, the illustration has been simplified such that many of the systems, subsystems and components utilized to facilitate communications are not shown. One skilled in the relevant art will appreciate that such components or subcomponents can be utilized and that additional interactions would accordingly occur without departing from the spirit and scope of the present invention.

As illustrated in FIG. 4A, at (1), during the operation of the mobile communication device 104, or during an initialization of the mobile communication device, the mobile communication device interface component 306 obtains a set of inputs indicative of the initiation of movement for the mobile communication device 104. For example, a location component may determine that the device has been put into motion. Alternatively, a user associated with the mobile telecommunication device 104 may indicate the initiation of trip via an interface. Accordingly, a movement state associated with the mobile telecommunication device 104 is determined to be in a non-stationary state. Illustratively, the non-stationary state may correspond to a single non-stationary state. Alternatively, the movement state may one of a number of potential non-stationary states.

At (2), the communication management system communication component 302 than transmits the mobile communication device context information to the communication management system 102 as appropriate. Specifically, in an illustrative embodiment, to reduce power consumption or bandwidth consumption, the communication management system communication component 302 may limit the transmission of mobile communication device context information for the initialization of a mobile communication device context, a detection of a change in mobile communication device context and/or for the re-establishment of a mobile communication device context.

At (3), at some point thereafter, the mobile telecommunication device 104 determines that a movement state associated with the mobile telecommunications device has transitioned to a stationary state (or substantially stationary state). For example, movement state information associated with the mobile telecommunication device 104 may fall below a velocity threshold or a distance threshold. In another example, movement state information associated with an external source, such as vehicle velocity information may indicate a substantially stationary state. By way of illustrative example, assume a vehicle is required to stop according to a traffic light. The mobile telecommunication device 104 can be considered to have transitioned to a stationary state.

In accordance with the illustrative embodiment, although the movement state associated with the mobile telecommunication device 104 has transitioned to a stationary state, the mobile telecommunication device context is not yet modified. Rather, at (4), the mobile telecommunication device 104 initiates a guard period to determine whether the mobile telecommunication device will transition again to a non-stationary movement state. Illustratively, the guard period will be defined as a fixed time period. In some embodiment, the guard period may be a default time period specified by an individual, such as a user associated with the mobile telecommunication device 104, a system administrator associated with a mobile service provider, an affiliated organization, or the like. In other embodiments, the guard period may be selected from a set of possible guard periods. In these embodiments, different guard periods may be reflective of previous user behavior, such as average stop times, reflexes, etc. Alternatively, the guard periods may be reflective of external environments, such as traffic conditions, time of day, road conditions, road classifications, special events (such as sporting events) and the like.

With continued reference to FIG. 4A, in one alternative, at (5′), prior to the expiration of the guard period, the mobile telecommunication device is considered to transition again to a non-stationary movement state. With reference to the previous illustrative example, if the vehicle stopped at the traffic light begins moving again when the traffic light permits travel, the mobile telecommunication device 104 can be considered to have transitioned or returned to a non-stationary state. In some embodiments in which multiple non-stationary states can be defined, the transition to the non-stationary movement state does not have to result in a transition to the same non-stationary state, but can correspond to any defined non-stationary movement state. Because the mobile telecommunication device 104 has transitioned back to a non-stationary movement state, the mobile telecommunication device context (e.g., movement) has not been changed or modified. Accordingly, in one aspect, any restrictions or limitations to functionality associated with the operation of the mobile telecommunication device 104 remains in place. Additionally, in another aspect, the mobile telecommunication device 104 has not transmitted any changes in mobile telecommunication device context to the communication management system 102.

Turning now to FIG. 4B, in a second alternative, after the initiation of the guard period at (4), the mobile telecommunication device 104 does not transition to a non-stationary state or a user associated with the mobile telecommunication device provides a manual indication that the travel has been terminated. In this alternative, at (5″), the guard period expires or manual input is received and the mobile telecommunications device can be associated with an increased confidence value regarding the transition of the movement state of the mobile telecommunication device 104.

Accordingly, at (6″), the mobile telecommunication device context is modified and transmitted to the communication management system 102. In one aspect, any restrictions or limitations to functionality associated with the operation of the mobile telecommunication device 104 may change based on the confidence value of the transition. For example, one or more restrictions on functionality of the mobile telecommunication device 104 may be removed. Additionally, in another aspect, the mobile telecommunication device 104 has not transmitted any changes in mobile telecommunication device context to the communication management system 102. In this aspect, the communication management system 102 may change how various communication or data channel requests to and from the mobile telecommunication device will be processed until the mobile telecommunication device context is subsequently changed.

### Mobile Device Context Assessment Algorithms

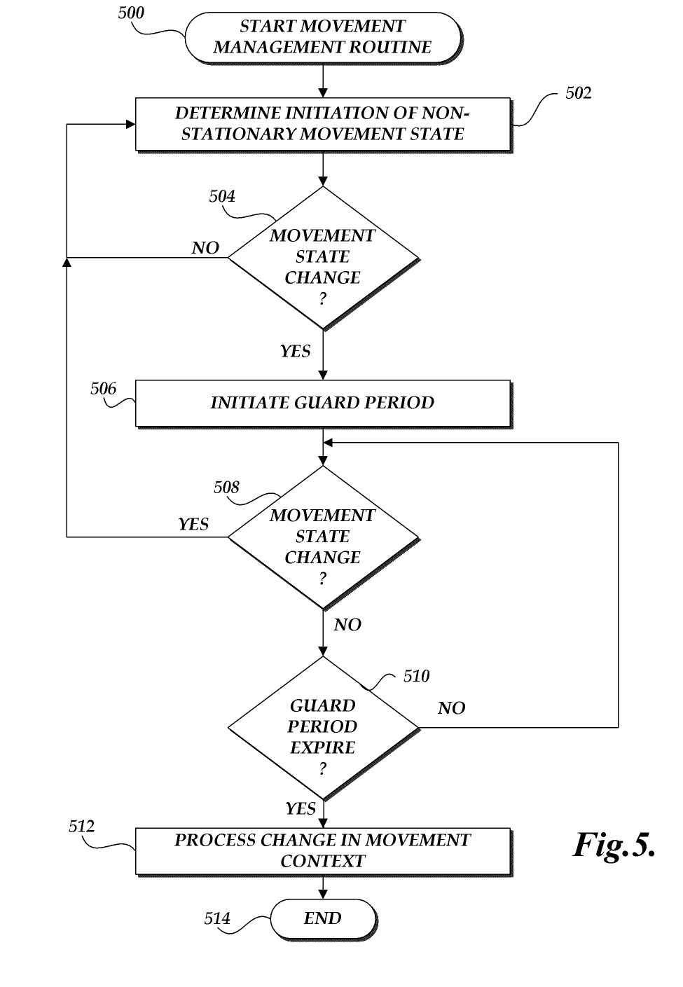

With reference now to FIG. 5, an illustrative routine 500 implemented by the mobile communication device context processing component 304 for determining context information of a mobile communication device 104 will be described. As described above, the mobile communication device context can correspond to a determination of a specific movement state indicative of a current mobile communication device environment. The availability for a data communications may be based on the determined transit state and the appropriate mobile communication device profile.

At block 502, the during the operation of the mobile communication device 104, or during an initialization of the mobile communication device, the mobile communication device interface component 306 obtains a set of inputs indicative of the initiation of movement for the mobile communication device 104. For example, a location component may determine that the device has been into motion. Alternatively, a user associated with the mobile telecommunication device 104 may indicate the initiation of trip via an interface. Accordingly, a movement state associated with the mobile telecommunication device 104 is determined to be in a non-stationary state. Illustratively, the non-stationary state may correspond to a single non-stationary state. Alternatively, the movement state may one of a number of potential non-stationary states.

At decision block 504, a test is conducted to determine whether a non-stationary movement state has changed. For example, movement state information associated with the mobile telecommunication device 104 may fall below a velocity threshold or a distance threshold. In another example, movement state information associated with an external source, such as vehicle velocity information may indicate a substantially stationary state. Illustratively, a movement threshold may be statically defined. Alternatively, the movement threshold may be dynamic based on attributes of the mobile telecommunication device 104, a user or other factor. If no change in the non-stationary movement state has occurred, the routine 500 returns to block 502.

Alternatively, if change in a non-stationary movement state associated with the mobile telecommunication device has occurred, at block 506, the mobile telecommunication device 104 initiates a guard period to determine whether the mobile telecommunication device will transition again to a non-stationary movement state. Illustratively, the guard period will be defined as a fixed time period. In some embodiment, the guard period may be a default time period specified by an individual, such as a user associated with the mobile telecommunication device 104, a system administrator associated with a mobile service provider, an affiliated organization, or the like. In other embodiments, the guard period may be selected from a set of possible guard periods. In these embodiments, different guard periods may be reflective of previous user behavior, such as average stop times, reflexes, etc. Alternatively, the guard periods may be reflective of external environments, such as traffic conditions, time of day, road conditions, road classifications, special events (such as sporting events) and the like.

At decision block 508, a test is conducted to determine whether the mobile telecommunication device 104 has transitioned to a non-stationary movement state during the guard period. In some embodiments in which multiple non-stationary states can be defined, the transition to the non-stationary movement state does not have to result in a transition to the same non-stationary state, but can correspond to any defined non-stationary movement state. If so, the routine 500 returns to block 502. Because the mobile telecommunication device 104 has transitioned back to a non-stationary movement state, the mobile telecommunication device context (e.g., movement) has not been changed or modified. Accordingly, in one aspect, any restrictions or limitations to functionality associated with the operation of the mobile telecommunication device 104 remains in place. Additionally, the mobile telecommunication device 104 has not transmitted any changes in mobile telecommunication device context to the communication management system 102.

If the mobile telecommunication device 104 has not transitioned to a non-stationary movement state, at decision block 510, a test is conducted to determine whether the guard period has expired. If not, the routine 500 returns to decision block 508. Alternatively, if the guard period has expired without a transition to a non-stationary movement state, at block 512, the mobile telecommunication device movement state is considered to be valid and a mobile communication device context can be designated as reflective of a stationary state. In one aspect, the mobile telecommunication device context is modified and transmitted to the communication management system 102. Accordingly, in one aspect, any restrictions or limitations to functionality associated with the operation of the mobile telecommunication device 104 may change based on the confidence value of the transition. For example, one or more restrictions on functionality of the mobile telecommunication device 104 may be removed. Additionally, the mobile telecommunication device 104 has not transmitted any changes in mobile telecommunication device context to the communication management system 102. In this aspect, the communication management system 102 may change how various communication or data channel requests to and from the mobile telecommunication device will be processed until the mobile telecommunication device context is subsequently changed. At block 514, the routine 500 terminates.

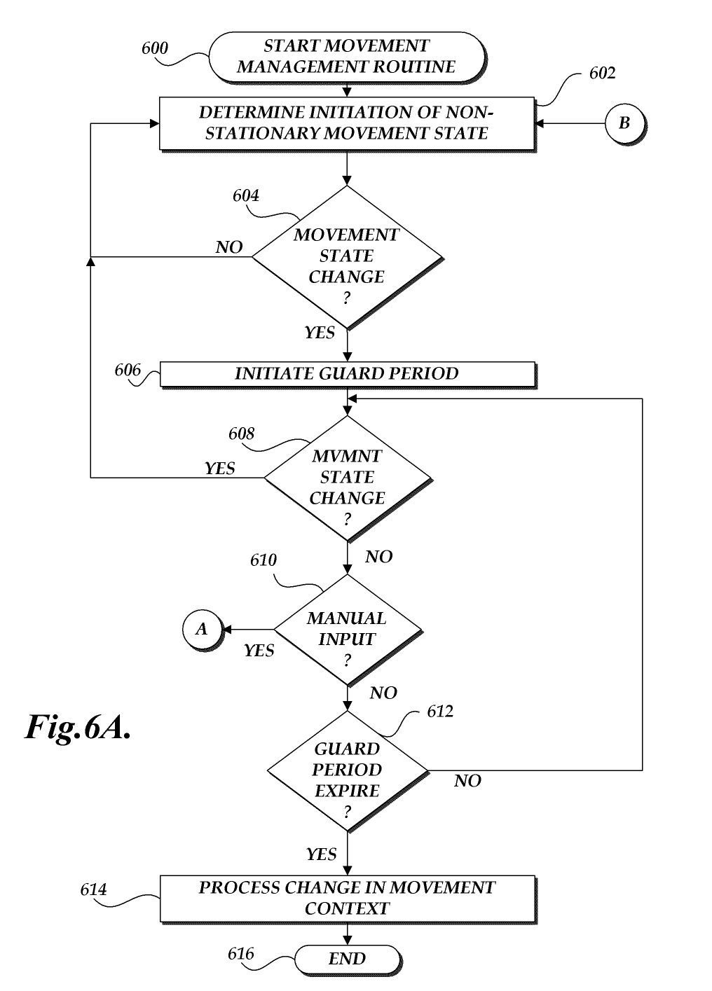

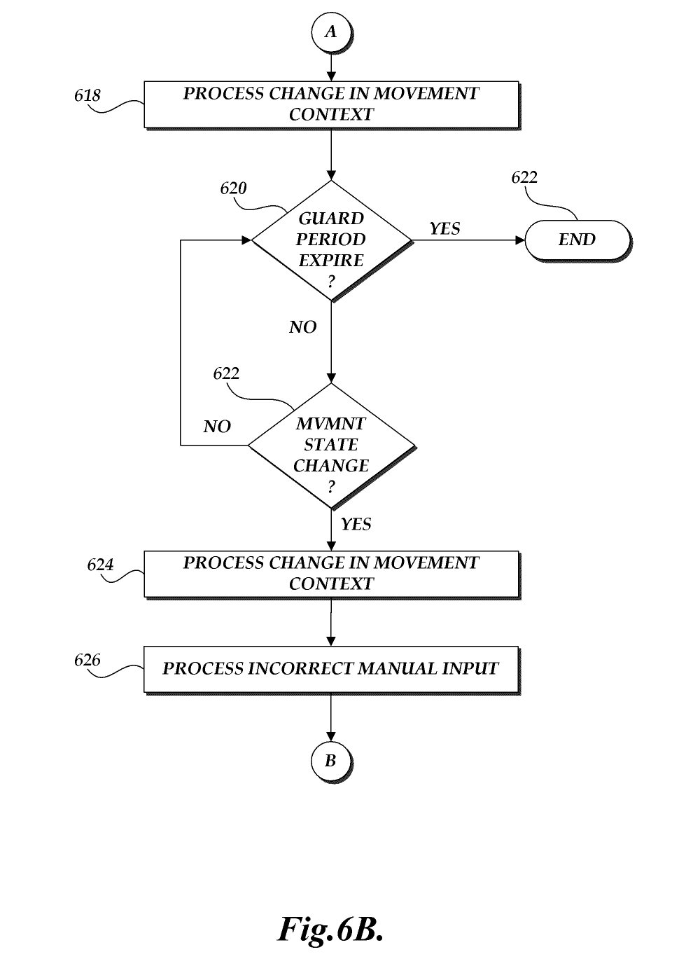

With reference now to FIGS. 6A and 6B, an illustrative routine 600 implemented by the mobile communication device context processing component 304 for determining context information of a mobile communication device 104 will be described. As described above, the mobile communication device context can correspond to a determination of a specific movement state indicative of a current mobile communication device environment. The availability for a data communications may be based on the determined transit state and the appropriate mobile communication device profile.

With reference to FIG. 6A, at block 602, the during the operation of the mobile communication device 104, or during an initialization of the mobile communication device, the mobile communication device interface component 306 obtains a set of inputs indicative of the initiation of movement for the mobile communication device 104. For example, a location component may determine that the device has been into motion. Alternatively, a user associated with the mobile telecommunication device 104 may indicate the initiation of trip via an interface. Accordingly, a movement state associated with the mobile telecommunication device 104 is determined to be in a non-stationary state. Illustratively, the non-stationary state may correspond to a single non-stationary state. Alternatively, the movement state may one of a number of potential non-stationary states.

At decision block 604, a test is conducted to determine whether a non-stationary movement state has changed. For example, movement state information associated with the mobile telecommunication device 104 may fall below a velocity threshold or a distance threshold. In another example, movement state information associated with an external source, such as vehicle velocity information may indicate a substantially stationary state. Illustratively, a movement threshold may be statically defined. Alternatively, the movement threshold may be dynamic based on attributes of the mobile telecommunication device 104, a user or other factor. If no change in the non-stationary movement state has occurred, the routine 600 returns to block 602.

Alternatively, if change in a non-stationary movement state associated with the mobile telecommunication device has occurred, at block 606, the mobile telecommunication device 104 initiates a guard period to determine whether the mobile telecommunication device will transition again to a non-stationary movement state. Illustratively, the guard period will be defined as a fixed time period. In some embodiment, the guard period may be a default time period specified by an individual, such as a user associated with the mobile telecommunication device 104, a system administrator associated with a mobile service provider, an affiliated organization, or the like. In other embodiments, the guard period may be selected from a set of possible guard periods. In these embodiments, different guard periods may be reflective of previous user behavior, such as average stop times, reflexes, etc. Alternatively, the guard periods may be reflective of external environments, such as traffic conditions, time of day, road conditions, road classifications, special events (such as sporting events) and the like.

At decision block 608, a test is conducted to determine whether the mobile telecommunication device 104 has transitioned to a non-stationary movement state during the guard period. In some embodiments in which multiple non-stationary states can be defined, the transition to the non-stationary movement state does not have to result in a transition to the same non-stationary state, but can correspond to any defined non-stationary movement state. If so, the routine 600 returns to block 602. Because the mobile telecommunication device 104 has transitioned back to a non-stationary movement state, the mobile telecommunication device context (e.g., movement) has not been changed or modified. Accordingly, in one aspect, any restrictions or limitations to functionality associated with the operation of the mobile telecommunication device 104 remains in place. Additionally, the mobile telecommunication device 104 has not transmitted any changes in mobile telecommunication device context to the communication management system 102.

If the mobile telecommunication device 104 has not transitioned to a non-stationary movement state, at decision block 610, a test is conducted to determine whether a manual input identifying a transition to a stationary state has been received. Illustratively, a user may be presented with an interface in which the user can designate a termination of a drive (or a transition to a stationary state prior to the expiration of the guard period. If no manual input is received at decision block 610, at decision block 612, a test is conducted to determine whether the guard period has expired. If not, the routine 600 returns to decision block 608.

Alternatively, if the guard period has expired without a transition to a non-stationary movement state, at block 614, the mobile telecommunication device movement state is considered to be valid and a mobile communication device context can be designated as reflective of a stationary state. In one aspect, the mobile telecommunication device context is modified and transmitted to the communication management system 102. Accordingly, in one aspect, any restrictions or limitations to functionality associated with the operation of the mobile telecommunication device 104 may change based on the confidence value of the transition. For example, one or more restrictions on functionality of the mobile telecommunication device 104 may be removed. Additionally, the mobile telecommunication device 104 has not transmitted any changes in mobile telecommunication device context to the communication management system 102. In this aspect, the communication management system 102 may change how various communication or data channel requests to and from the mobile telecommunication device will be processed until the mobile telecommunication device context is subsequently changed. At block 616, the routine 600 terminates.

Turning to FIG. 6B, returning to decision block 610 (FIG. 6A), if a manual input is received, at block 618, the mobile telecommunication device movement state is considered to be valid and a mobile communication device context can be designated as reflective of a stationary state. In one aspect, the mobile telecommunication device context is modified and transmitted to the communication management system 102. Accordingly, in one aspect, any restrictions or limitations to functionality associated with the operation of the mobile telecommunication device 104 may change based on the confidence value of the transition. For example, one or more restrictions on functionality of the mobile telecommunication device 104 may be removed. Additionally, the mobile telecommunication device 104 has not transmitted any changes in mobile telecommunication device context to the communication management system 102. In this aspect, the communication management system 102 may change how various communication or data channel requests to and from the mobile telecommunication device will be processed until the mobile telecommunication device context is subsequently changed.

Additionally, even though the mobile telecommunication device context has been modified, at decision block 620, a test is conducted to determine whether the guard period has expired. If so, the routine 600 terminates at block 622 and no modification to the mobile telecommunication device context is needed. If the guard period has not yet expired at decision block 620, at decision block 622, a test is conducted to determine whether the mobile telecommunication device 104 has transitioned to a non-stationary movement state during the guard period. In this embodiment, the transition of the mobile telecommunication device to a non-stationary state during the guard period after receipt of a manual input can be indicative a false manual input or error. If no transition has occurred, the routine 600 returns to decision block 620.

Alternative, if a transition is detected at decision block 622, at block 624, the mobile telecommunication device context is modified to reflective of a non-stationary movement state. Accordingly, in one aspect, any restrictions or limitations to functionality associated with the operation of the mobile telecommunication device 104 can be put in place again. Additionally, the mobile telecommunication device 104 can transmit any changes in mobile telecommunication device context to the communication management system 102. Additionally, at block 626, the indication of a false manual input or error is processed. Illustratively, a user may be presented with an interface identifying the potential error. Additionally, one or more notifications may be provided to the communication management system 102. For example, the communication management system 102 may be notified after a number of false processing.

A server or other computing component implementing any component may include a network interface, memory, processing unit, and computer readable medium drive, all of which may communicate with each other by way of a communication bus. For example, an included network interface may provide connectivity over the network and/or other networks or computer systems. A processing unit (as included may in any of the components discussed above) may communicate to and from memory containing program instructions that the processing unit executes in order to operate the storage management component and storage devices. An included memory may generally include RAM, ROM, other persistent and auxiliary memory, and/or any non-transitory computer-readable media.

All of the processes described herein may be embodied in, and fully automated via, software code modules executed by one or more general purpose computers or processors. The code modules may be stored in any type of computer-readable medium or other computer storage device. Some or all the methods may alternatively be embodied in specialized computer hardware. In addition, the components referred to herein may be implemented in hardware, software, firmware or a combination thereof.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer-implemented method for managing content, comprising:
associating a movement state context to a mobile device reflective of a determined movement state of the mobile device corresponding to a non-stationary state;
subsequently determining a first modification of the determined movement state of the mobile device indicative of a transition of the movement state to a substantially stationary state, wherein the determination of the modification does not cause a modification of the movement state context;
causing initiation of a first guard period to determine whether the movement state is further modified;
determining a second modification of the determined movement state of the mobile device indicative of a transition of the movement state to a non-stationary state prior to expiration of the first guard period;
subsequently determining a third modification of the determined movement state of the mobile device indicative of a transition of the movement state to a substantially stationary state, wherein the determination of the modification does not cause a modification of the movement state context;
causing initiation of a second guard period to determine whether the movement state is further modified;
determining an expiration of the second guard period; and
associating an updated movement state context reflective of the third modification to the movement state.

2. The computer-implemented method as recited in claim 1, wherein associating a movement state context to a mobile device reflective of a determined movement state of the mobile device corresponding to a non-stationary state includes associating a movement state based on a detection of movement.

3. The computer-implemented method as recited in claim 1, wherein associating a movement state context to a mobile device reflective of a determined movement state of the mobile device corresponding to a non-stationary state includes associating a movement state based on manual input.

4. The computer-implemented method as recited in claim 1, wherein subsequently determining a first modification of the determined movement state of the mobile device indicative of a transition of the movement state to a substantially stationary state includes determining a movement measurement below a threshold.

5. The computer-implemented method as recited in claim 1, wherein causing initiation of a first guard period to determine whether the movement state is further modified includes selecting a guard period from a plurality of applicable guard periods.

6. The computer-implemented method as recited in claim 5, wherein selecting the guard period includes selecting the guard period based on historical information associated with the mobile device.

7. The computer-implemented method as recited in claim 1 further comprising transmitting the updated movement state context.

8. The computer-implemented method as recited in claim 1 further comprising causing a modification of operation of one or more software applications associated with the mobile device based on the updated movement state context.

9. The computer-implemented method as recited in claim 1 further comprising receiving a manual input indicative of a modification of the movement state prior to the expiration of the first guard period.

10. The computer-implemented method as recited in claim 9 further comprising associating an updated movement state context reflective of the manual input and independent of the expiration of the first guard period.

11. The computer-implemented method as recited in claim 10, wherein determining a second modification of the determined movement state of the mobile device indicative of a transition of the movement state to a non-stationary state prior to expiration of the first guard period includes determining the second modification subsequent to receipt of the manual input.

12. The computer-implemented method as recited in claim 11 further comprising associating the second modification with the manual input.

13. An apparatus comprising:
a movement management component, executed by one or more hardware components executing instructions, wherein the movement management component:
associates a movement state context to a mobile device reflective of a determined movement state of the mobile device corresponding to a non-stationary state;
subsequently determines a first modification of the determined movement state of the mobile device indicative of a transition of the movement state to a substantially stationary state, wherein the determination of the modification does not cause a modification of the movement state context;
causes initiation of a first guard period to determine whether the movement state is further modified;
determines a second modification of the determined movement state of the mobile device indicative of a transition of the movement state to a non-stationary state prior to expiration of the first guard period;
subsequently determines a third modification of the determined movement state of the mobile device indicative of a transition of the movement state to a substantially stationary state, wherein the determination of the modification does not cause a modification of the movement state context;
causes initiation of a second guard period to determine whether the movement state is further modified;
determines an expiration of the second guard period; and
associates an updated movement state context reflective of the third modification to the movement state.

14. The apparatus as recited in claim 13, wherein the movement management component associates a movement state based on a detection of movement.

15. The apparatus as recited in claim 13, wherein the movement management component determines the first modification of the determined movement state of the mobile device indicative of a transition of the movement state to a substantially stationary state based on determining a movement measurement below a threshold.

16. The apparatus as recited in claim 13, wherein the movement management component selects a guard period from a plurality of applicable guard periods.

17. The apparatus as recited in claim 13 further comprising a transmission component, executed by one or more hardware components executing instructions for transmitting the updated movement state context.

18. The apparatus as recited in claim 13, wherein the movement management component causes modification of operation of one or more software applications associated with the mobile device based on the updated movement state context.

19. The apparatus as recited in claim 13, wherein the movement management component receives a manual input indicative of a modification of the movement state prior to the expiration of the first guard period and associates an updated movement state context reflective of the manual input and independent of the expiration of the first guard period.

20. The apparatus as recited in claim 19, wherein the movement management component determines the second modification of the determined movement state of the mobile device indicative of a transition of the movement state to a non-stationary state prior to expiration of the first guard period and subsequent to receipt of the manual input.

21. The apparatus as recited in claim 20, wherein the movement management component associates the second modification with the manual input.

22. A computer-implemented method for managing content, comprising:
setting a movement state context to a mobile device reflective of a determined movement state of the mobile device above a movement threshold;
subsequently determining a modification of the determined movement state of the mobile device indicative of a transition of the movement state below the movement threshold, wherein the determination of the modification does not cause a modification of the movement state context;
causing initiation of a guard period to determine whether the movement state is further modified;
associating an updated movement state context reflective of the modification to the movement state based on an expiration of the guard period.

23. The computer-implemented method as recited in claim 22 further comprising determining a second modification of the determined movement state of the mobile device indicative of a transition of the movement state above the movement threshold prior to expiration of the guard period.

24. The computer-implemented method as recited in claim 23 further comprising subsequently determining a third modification of the determined movement state of the mobile device indicative of a transition of the movement state to a substantially stationary state, wherein the determination of the modification does not cause a modification of the movement state context.

25. The computer-implemented method as recited in claim 22 further comprising receiving a manual input indicative of a modification of the movement state prior to the expiration of the guard period and associating an updated movement state context reflective of the manual input and independent of the expiration of the first guard period.
